(19) United States
(12) Patent Application Publication
(10) Pub. No.: US 2013/0328412 A1
(43) Pub. Date: Dec. 12, 2013

(54) FLAT COIL FOR A CONTACTLESS INDUCTIVE ENERGY TRANSMISSION

(71) Applicants: Jürgen Meins, Braunschweig (DE); Benedikt Schmülling, Herne (DE); Faical Turki, Berkamen (DE); Thomas Vosshagan, Drolshagen (DE)

(72) Inventors: Jürgen Meins, Braunschweig (DE); Benedikt Schmülling, Herne (DE); Faical Turki, Berkamen (DE); Thomas Vosshagan, Drolshagen (DE)

(73) Assignee: Paul Vahle Gmbh & Co. KG, Kamen (DE)

(21) Appl. No.: 14/001,071

(22) PCT Filed: Mar. 28, 2012
(86) PCT No.: PCT/EP12/55540

§ 371 Date: Aug. 22, 2013

(30) Foreign Application Priority Data
Jun. 30, 2011 (DE) 102011107620.8

(51) Int. Cl. H01F 38/14

(52) U.S. Cl. CPC H01F 38/14
USPC 307/104

(57) ABSTRACT

The invention relates to an inductive energy transmission system for the transfer of electrical energy between a base station and a movable consumer, in particular a vehicle, the energy transmission system being able to transfer electrical energy from a base station to the consumer and/or from the consumer to the base station, said energy transmission system comprising at least one primary-side flat coil (Sₚ), arranged in the base station, and a flat coil (Sₛ) arranged on the secondary side in the consumer, having a plurality of turns (3, 4) in each case, the turns (3, 4) being arranged concentrically or spirally around a centre (M), characterised in that there is a relative spacing (d₁) at least between some adjacent turns (13) of a primary-side flat coil (Sₚ), and the distance (9, 10) between the turn arranged closest to the centre (M) and the turn arranged furthest from the centre (M) in the primary-side coil (Sₚ) is greater than in a secondary-side coil (Sₛ).

The present invention relates to an inductive energy transfer system for the transmission of electrical energy between a base station and a movable consumer, in particular a vehicle, where electrical energy can be transferred by the energy transmission system from a base station to the consumer and/or from the consumer to the base station, the energy transfer system comprising at least one primary-side flat coil arranged in the base station and one flat coil arranged on the secondary side in the consumer having in each case a plurality of turns, the turns being arranged concentrically or spirally around a centre point.

For inductively charging a vehicle, a base station with a primary coil and a secondary-side pickup coil are required on the vehicle. The coils are generally configured as charge plates with flat coils, the base station often having dimensions of 1 m×1 m and the secondary-side pickup having dimensions of 0.8 m×0.8 m. The secondary-side pickup is preferably arranged as an undercarriage pickup under the vehicle. The windings of the primary-side and secondary-side flat coils are wound in a concentrated manner, i.e. the adjacent turns directly adjoin one another without a spacing. However, they do not necessarily have to be adjacent to one another. In this respect, the coils can be wound concentrically or spirally.

An alternating current which generates a magnetic alternating field is fed into the primary coil. This magnetic field is coupled with the secondary coil by the coupling factor k and there it induces an electrical voltage. However, with the concentrated windings used hitherto, it is generally only possible to generate a low coupling which is subject to many factors, in particular to the spacing of the flat coils relative to one another.

It is also known to wind flat coils such that the adjacent turns have a spacing from one another so that a specific magnetic field is produced above the coil, in order to be able to form parts using this magnetic field.

It is therefore the object of the present invention to improve a generic system such that it has a higher coupling factor. This object is achieved by a system having the features of claim 1. Advantageous configurations are provided by the features of the subclaims.

The invention is based on the idea that it is possible to generate a magnetic field by flat coils which are not wound in a concentrated manner, with which magnetic field a higher and thereby better coupling is produced between the primary-side flat coil and the secondary-side flat coil. This is achieved in that a flat coil with windings, of which at least some of the adjacent turns are in a spacing from one another is used at least for the primary-side coil. This can advantageously influence the field distribution, as a result of which an improved coupling can be achieved in that the proportion of the magnetic flux which is generated by the primary coil and is coupled with the secondary coil is significantly increased. The improved coupling advantageously produces higher efficiencies, so that a relatively small primary current is required to generate the same secondary voltage. Due to the improved efficiency or to the improved coupling, alternatively the same secondary voltage can advantageously be generated with a smaller number of turns. A smaller number of turns advantageously reduces the ohmic losses in the coil. Consequently, due to the smaller apparent current, the reactive power requirement decreases, as a result of which the losses are advantageously reduced.

Due to the spacings used of the individual turns relative to one another, a homogeneous field can be produced, as a result of which local field maxima are avoided which could lead locally to the exceeding of legal limiting values or of limiting values required for functional safety. However, it is not necessary for all the turns which are arranged next to one another to be spaced apart from one another. It is also possible for some adjacently arranged turns or winding wires to be arranged directly against each another or to be arranged in an insignificant spacing from one another.

The homogenisation of the magnetic field between the primary-side and secondary-side arrangement also means that the magnetically conductive material of the loop-back yokes of the primary side and secondary side are utilised more effectively and thus this has to be of an advantageously thinner configuration. Consequently, material and weight is reduced, which entails lower production costs and a lower energy consumption by the vehicle. To obtain the most homogeneous magnetic field possible at least in the region of the turns of the secondary side, there is a spacing at least between some adjacent turns of the primary-side flat coil and, at the same time, the distance between the turn arranged closest to the centre and the turn arranged furthest from the centre in the case of the primary-side coil is greater than in the case of a secondary-side coil. This means that the winding regions of the primary-side flat coil and of the secondary-side flat coil are configured in different widths.

The spacings between the adjacent turns of the primary-side coil are to be calculated such that they are greater than the diameter of the winding wire. Turn distribution and the spacings of the turns relative to one another are particularly to be established empirically or by suitable simulation programs. Optimisation methods can also be used which calculate the optimum turn arrangement for the respective case of application.

Thus, it can be advantageous for the spacing between the individual turns to decrease from the centre out to the outermost turn or for the spacings between adjacent turns relative to one another to differ in size at least to some extent.

It can also be advantageous for the inner turn of the primary-side flat coil to be arranged nearer the centre than the inner turn of the secondary-side flat coil and/or for the outermost turn of the primary-side flat coil to be arranged further away from the centre than the outermost turn of the secondary-side flat coil.

The turns of the secondary-side flat coil can be arranged in a concentrated manner relative to one another, i.e. next to one another, in particular adjoining one another. This measure advantageously provides a minimum width of the turn region of the secondary coil, so that the magnetic field only has to be configured homogeneously in a small region, which lowers the requirements on the turn distribution of the primary coil.

Of course, the numbers of turns can be freely selected for the respectively required purpose of use. If, inter alia, a bidirectional energy and/or data transmission is, however, also to be provided, the numbers of turns of the primary-side flat coil and of the secondary-side flat coil are advantageously selected to be the same.

The primary-side flat coil and the secondary-side flat coil can naturally be of a circular, rectangular or oval configuration. It is also possible for the turns to be wound either spirally or concentrically.

To enable a bidirectional transfer of energy, in a development of the inductive energy transfer system according to the invention, the base station can have a respective flat coil wound in a concentrated manner as well as a flat coil with mutually spaced-apart turns, the secondary-side consumer side also having a respective flat coil wound in a concentrated manner as well as a flat coil with mutually spaced-apart turns. In this respect, depending on the transfer direction, in each case the flat coil with a concentrated winding is used as the secondary-side flat coil and the flat coil with mutually spaced-apart turns is used as the primary-side flat coil. Thus, depending on the transfer direction, one or the other flat coil on the side of the base station and of the vehicle is used.

Likewise, it is possible for the primary-side flat coil and/or for the secondary-side flat coil to each have a turn region with turns which are wound in a concentrated manner relative to one another and to have at least one turn region, the adjacent turns of which are spaced apart from one another. In a development of this embodiment, switching means can be provided, by which one or more turn regions can be activated and can thus be connected to an electronic system which is connected upstream or downstream. Consequently, the generated magnetic field can be influenced by the choice of the activated turn regions. A flat coil of this type can thus be used as a transmitter coil with mutually spaced-apart turns and can also be used as a receiver coil, i.e. a secondary-side coil with a concentrated winding.

It is also possible for the primary-side flat coil and/or for the secondary-side flat coil to each have at least one single turn or a least one turn region which is arranged displaceably relative to other turns and/or the diameter of which can be changed such that the magnetic field generated by this flat coil is variable. As a result, the coupling factor can be adaptively optimised during operation or during the start-up procedure.

Advantageously, the coupling factor is not substantially affected by a slight lateral offset of the primary-side arrangement relative to the secondary-side arrangement by the turn arrangement according to the invention. This is advantageously achieved in that the magnetic field of the primary coil is substantially more homogeneous in the region of the secondary coil than in the case of a primary coil with a concentrated winding.

In the following, the inductive energy transfer system according to the invention will be described in more detail with reference to drawings, in which:

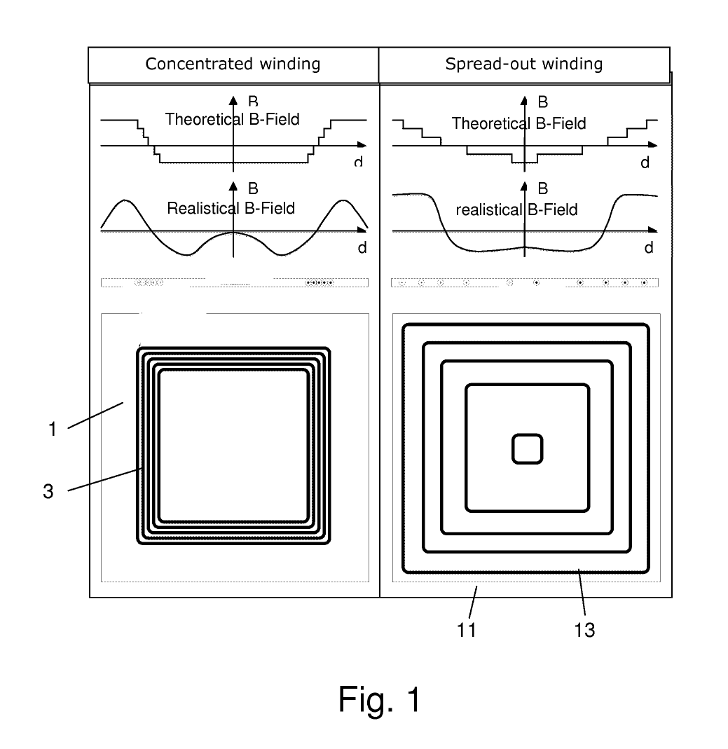

FIG. 1 shows a magnetic field of a flat coil wound in a concentrated manner and of a flat coil with turns which are spread out and spaced apart from one another;

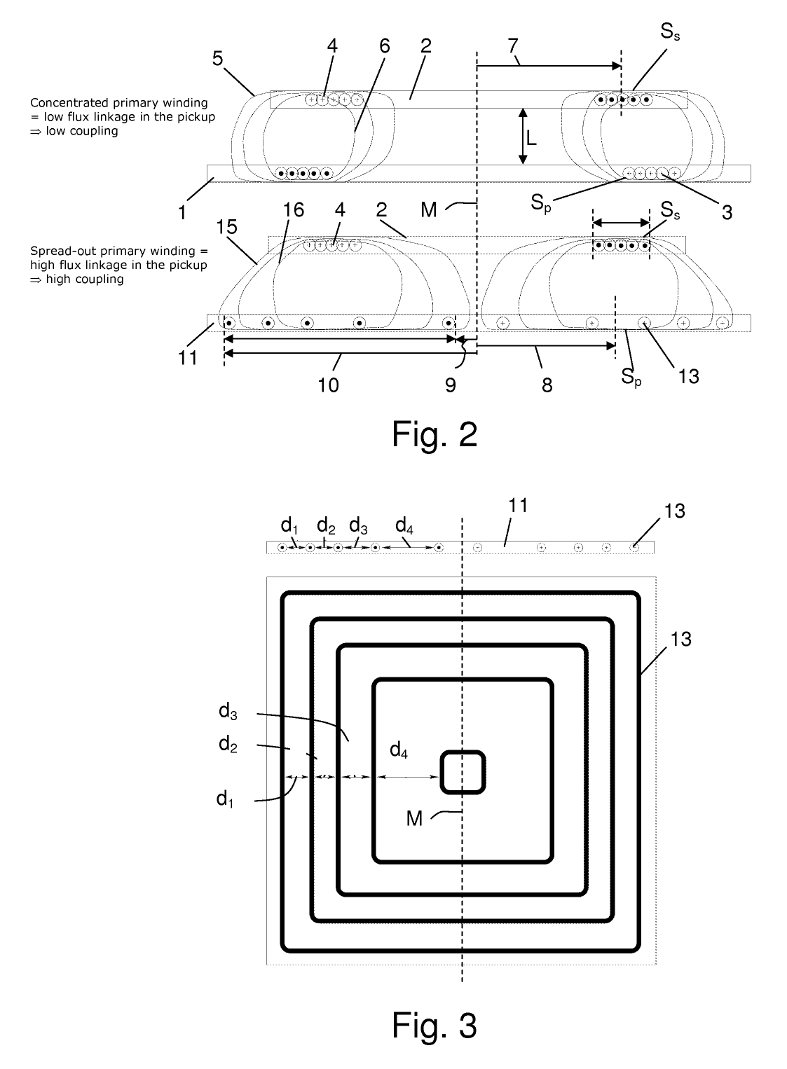

FIG. 2 shows a comparative field distribution;

FIG. 3 is a cross-sectional and plan view of a flat coil having spaced-apart turns;

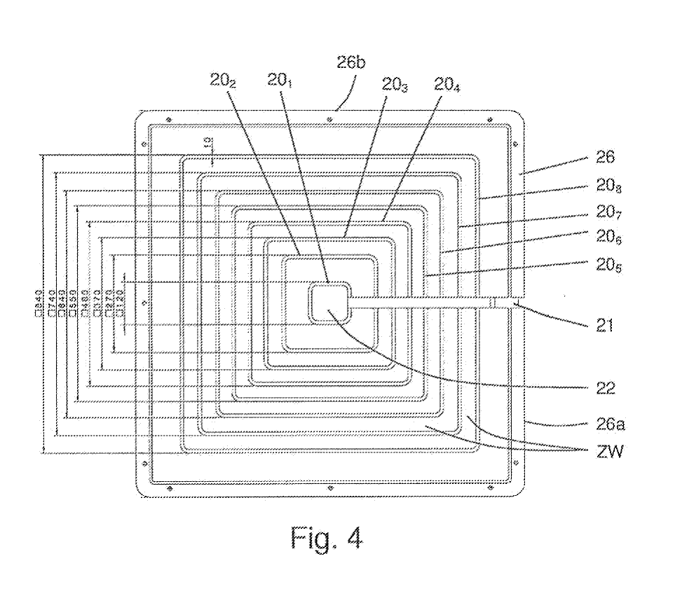

FIG. 4 is a plan view of the cover of the carrier for the primary winding;

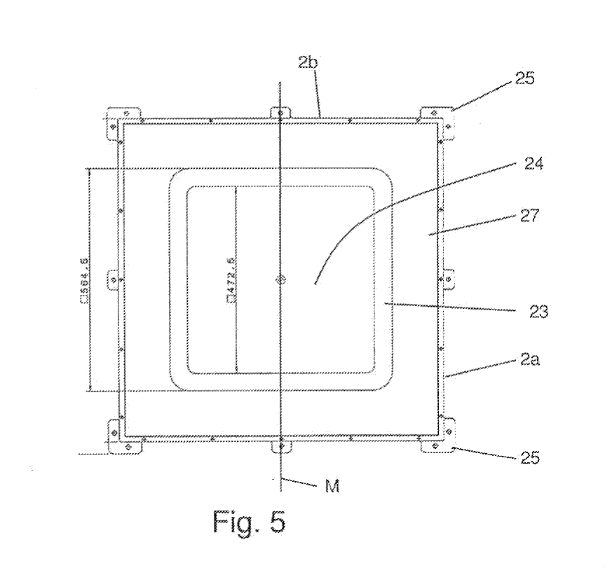

FIG. 5 is a plan view of the cover of the carrier for the secondary winding;

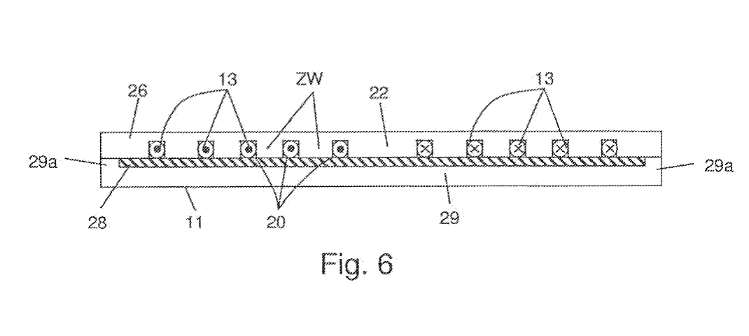

FIG. 6 is a cross-sectional view through the carrier for the primary winding.

FIG. 1 shows, on the left-hand side, a plan view and a side view of the stationary charge plate 1 with a concentrated winding 3. The theoretically occurring orthogonal B-field and the orthogonal B-field, which occurs under realistic conditions, of the flat coil with a concentrated winding 3 are shown above this view. The differences between theory and practice are mainly caused by the large air gap L (see FIG. 2) between charge plate 1 and pickup 2 of usually at least 80 mm. As a result, the B-field is concentrated rather in the vicinity of the winding 3 instead of uniformly utilising the entire charge plate 1. Therefore, the centre M of the charge plate 1 remains, for example, to a large extent without B-field.

The right-hand side of FIG. 1 shows a flat coil 11 with turns 13 which are spread out and spaced apart from one another. The theoretically occurring orthogonal B-field and the orthogonal B-field, which occurs under realistic conditions, of the right-hand flat coil 13 are shown above this view. A better utilisation of the available space was achieved through simulations by arranging the turns in a spread-out manner, as a result of which a more homogeneous magnetic field is produced above the primary coil. In this respect, the individual spacings d₁ can all be different from one another, although they do not have to be. The amount of the realistic B-field (at the bottom) is approximately homogeneous over the entire length d of the charge plate and is more similar to the theoretic field (top left) of the concentrated winding 3 (left-hand winding).

FIG. 2 shows the charge plate 1, 11 of the base station and the pickup 2 in a side view. In the top illustration, the winding 3 of the charge plate 1 is formed from a standard flat coil Sₛ, Sₚ having turns arranged in a concentrated manner. In the generic solution, the magnetic field lines 5, 6 do not include all the turns 4 of the secondary coil Sₛ. In the bottom illustration, the winding 13 is configured as a spread-out flat coil Sₚ. FIG. 2 illustrates that due to the spread or spacing apart of the adjacent turns 13, it is possible to link a relatively great proportion of the generated magnetic flux 15, 16 with the secondary-side pickup winding 4. This increases the coupling between primary side and secondary side Sₛ, Sₚ.

Due to the improved coupling, a smaller primary current is required to generate the same induction voltage on the secondary side compared to a system with a poorer coupling. Therefore, the efficiency of the system is greater compared to generic systems having concentrated windings. FIG. 3 again shows the flat coil Sₚ, on an enlarged scale, with spaced-apart turns 13. The spacings d₁ to d₄ are to be selected in each case such that a B-field is produced, the magnetic field lines 15, 16 of which as far as possible include all the turns of the secondary-side winding 4. The turns are arranged concentrically around the centre M. In this respect, the individual turns can be interconnected by orthogonal connecting webs which are not shown here. The windings can be square, as shown. However, they can also be rectangular, oval or circular. Likewise, the turns can be arranged spirally around the centre. A rectangular shape is appropriate when the pickup coil is arranged in the region of the number plate of a vehicle, for example.

FIGS. 4 and 5 are plan views of the covers 26, 27 of the carriers 11 and 2 for the primary and secondary windings. In this respect, the spacings of the individual turns of the primary coil are selected such that a homogeneous magnetic field is produced between the primary coil and the secondary coil with a spacing of approximately 90 mm to 180 mm.

It has proved to be advantageous for the active primary current to be approximately 9 A to 14 A. In this respect, care should be taken that the current is not so high that the flux conduction material becomes saturated. The frequency can be within a range of from 120 to 180 KHz. In the illustrated embodiment according to FIGS. 4 and 5, the primary winding has eight turns and the secondary winding also has eight turns.

The flat windings are rectangular, the individual turns being arranged concentrically to one another. Of course, it is also possible for the turns to be configured spirally.

The covers 26, 27 have peripheral recesses 20₁₋₈ and 23 which can be formed, for example, by impressed, milled or moulded grooves. The wires of the windings are arranged in the recesses 20₁₋₈ and 23 or they lie therein. It is naturally possible to provide, instead of the recesses 20₁₋₈ and 23, lateral boundaries, for example in the form of elevations or projections which keep the winding wires in position and keep them spaced apart from one another. A respective winding wire forming a turn can lie in each rectangular recess 20₁₋₈ of the primary-side carrier 26. Of course, it is also possible for a plurality of winding wires, for example one, two or more, to be arranged in parallel and to lie in each recess 20₁₋₈. The winding wires are guided via the recess 21 to the individual recesses 20₁₋₈. Recess 21 is arranged orthogonally to recesses 20₁₋₈, so that the current which flows through the winding portions lying in recess 21 does not have any effect on the generated magnetic field of the primary coil arrangement. The recesses 20₁₋₈ are spaced apart from one another by the intermediate regions ZW, thus producing a spread-out winding. The dimensions of the recesses 20₁₋₈ are specified in FIG. 4. The recesses 20₁₋₈ configured as grooves each have a width of 10 mm. The innermost recess 20₁ has an external diameter of 120 mm. The centre of the innermost winding wire thus has a spacing from the centre of 115 mm. Recess 20₂ comprising the innermost recess 20₁ as the closest has an external diameter of 270 mm.

The sides 26a, 26b of the cover 26 are of the same length in each case, so that the cover is square. However, it is also possible for the cover 26 and thus the carrier 11 to be rectangular.

The winding wires of the secondary winding are arranged in the recess 23 which extends around the central region 24 of the carrier 2. The winding wires lie next to one another and are only separated from one another by the electrically insulating material. The cover 27 has fastening points 25 for attachment to a vehicle, for example.

FIG. 6 is a cross-sectional view through the primary-side coil arrangement. The carrier 11 has a cover 26 which is preferably produced from a glass fibre composite material and has recesses 20 in the form of grooves, in which the winding wires 13 lie. A ferrite plate 28 as flux conduction material is arranged on a base plate 29 which can be produced from aluminium, for example. The ferrite plate 28 can also be composed of small stacked ferrite platelets. The cover 26 and the base plate 29 are screwed together at the sides 29a. The width of the intermediate regions ZW determines the spacing of the mutually adjacent winding wires 13 or turns.

The covers of the primary-side and secondary-side carriers are advantageously produced from a light, robust and rigid material so that the windings are effectively protected against external mechanical forces. Nowadays, ferrite material is generally used as flux conduction material and, because it is brittle, there is the danger that it will be destroyed by external forces. Therefore, it must be ensured that the carrier adequately protects the ferrite material 28 against destruction.

1. An inductive energy transmission system for the transfer of electrical energy between a base station and a movable consumer, the energy transmission system being able to transfer electrical energy from a base station to the consumer and/or from the consumer to the base station, said energy transmission system comprising:
at least one primary-side flat coil, arranged in the base station and having a plurality of turns arranged concentrically or spirally around a center and a relative spacing at least between some adjacent turns, and
a flat coil arranged on the secondary side in the consumer and having a plurality of turns arranged concentrically or spirally around a center,
wherein a distance between a turn arranged closest to the center and a turn arranged furthest from the center in the at least one primary-side coil is greater than in a secondary-side coil.

2. The inductive energy transmission system according to claim 1, wherein at least some adjacent turns of the primary-side coil have a spacing from one another which is greater than a diameter of the winding wire, and preferably corresponds to at least 2 to 10 times the diameter of the winding wire.

3. The inductive energy transmission system according to claim 1, wherein a spacing between individual turns in the at least one primary-side coil decreases from the center out to an outermost turn, or wherein spacings between adjacent turns of the at least one primary-side coil differ in size, relative to one another, at least to some extent.

4. The inductive energy transmission system according to claim 1, wherein an inner turn of the at least one primary-side flat coil is arranged closer to the center than an inner turn of the secondary-side flat coil, and/or wherein an outermost turn of the at least one primary-side flat coil is arranged further away from the center than an outermost turn of the secondary-side flat coil.

5. The inductive energy transmission system according to claim 1, wherein the turns of the secondary-side flat coil are arranged in a concentrated manner relative to one another such that they are adjoining one another.

6. The inductive energy transmission system according to claim 1, wherein the turns of the at least one primary-side flat coil are arranged spread out such that a magnetic field above the at least one primary-side coil is as homogeneous as possible in terms of amount.

7. The inductive energy transmission system according to claim 6, wherein the magnetic field does not have any local field maxima, such that the maximum magnetic field intensity does not exceed a legally or technically mandated limiting value.

8. The inductive energy transmission system according to claim 1, wherein the at least one primary-side flat coil and the secondary-side flat coil have the same number of turns.

9. The inductive energy transfer system according to claim 1, wherein the primary-side and secondary-side coils have a circular, rectangular or oval configuration and/or the turns are either spiral or concentric.

10. The inductive energy transmission system according to claim 1, wherein the base station has a respective flat coil wound in a concentrated manner as well as a flat coil with mutually spaced-apart turns, and/or wherein the secondary-side consumer side has a respective flat coil wound in a concentrated manner as well as a flat coil with mutually spaced-apart turns, such that bidirectional electrical energy and/or data can be transferred between base station and consumer, it being possible for energy and/or data to be transferred in each case by a flat coil having mutually spaced-apart turns to a flat coil wound in a concentrated manner.

11. The inductive energy transmission system according to claim 1, wherein the at least one primary-side flat coil and/or the secondary-side flat coil has a turn region with turns wound in a concentrated manner relative to one another and has at least one turn region, the adjacent turns of which are spaced apart from one another.

12. The inductive energy transmission system according to claim 11, further comprising switching means configured to activate one or more turn regions and to connect the one or more turn regions to an electronic system connected upstream or downstream of the one or more turn regions.

13. The inductive energy transmission system according to claim 11, wherein the turn region wound in a concentrated manner is used as the secondary-side coil to receive electrical energy, and wherein all the turn regions or only specific turn regions having mutually spaced-apart turns form the at least one primary-side coil.

14. The inductive energy transmission system according to claim 1, wherein the at least one primary-side flat coil and/or the secondary-side flat coil has at least a single turn or turn regions which are arranged displaceably relative to other turns and/or the diameter of which can be changed such that the magnetic field generated can be varied.

15. The inductive energy transmission system according to claim 1, wherein the secondary-side flat coil is arranged under a vehicle or in a region of the front or rear of the vehicle, in particular in the region of the number plate.

16. The inductive energy transmission system according to claim 2, wherein said spacing corresponds to at least 2 to 10 times the diameter of the winding wire.

17. The inductive energy transmission system according to claim 1, wherein the secondary-side flat coil is arranged under in a region of a number plate of a vehicle.
